(19) United States
(12) Patent Application Publication
(10) Pub. No.: US 2026/0262771 A1
(43) Pub. Date: Sep. 10, 2026

(54) Firefighter Glove Assembly Comprising Flame and Heat-Resistant Outer Glove and Flame and Particulate-Resistant Glove Insert

(71) Applicant: SP ASIA HOLDING, LLC, WILMINGTON, DE (US)

(72) Inventor: JIAN XIANG, MIDLOTHIAN, VA (US)

(21) Appl. No.: 19/381,509

(22) Filed: Nov. 6, 2025

Related U.S. Application Data
(60) Provisional application No. 63/717,430, filed on Nov. 7, 2024.
(60) Provisional application No. 63/757,578, filed on Feb. 12, 2025.

(51) Int. Cl. A41D 19/015

(52) U.S. Cl. CPC A41D 19/01529

(57) ABSTRACT

A glove assembly comprising a flame and heat-resistant outer glove and a separable, flame and particulate-resistant glove insert; and the glove insert itself; the glove insert comprising a particulate-resistant barrier laminate comprising:
a) an exterior layer of knit fabric having a basis weight of 33.9 to 101.7 g/m² and a tightness factor of 0.9 to 1.9;
b) a middle layer comprising flame resistant nonwoven fabric comprising fibers having a diameter of less than 1000 nm, wherein the nonwoven fabric has stretch and recovery; and
c) an interior layer of knit fabric having a basis weight of 33.9 to 101.7 g/m², wherein a), b) and c) are flame resistant, with a) and c) discontinuously attached to b) by adhesive, the total basis weight of the laminate being 93 to 294 g/m².

### BACKGROUND OF THE INVENTION

Field of the Invention. This invention relates to a glove assembly suitable for use by firefighters and other personnel in hazardous environments, and a washable flame and particulate-resistant glove insert used in that glove assembly. The glove assembly comprises a flame and heat-resistant outer glove and a separable, washable, and reusable flame and particulate-resistant glove insert configured to fit over a person's hand and inside the flame and heat-resistant outer glove.

Description of Related Art Personal protective equipment (PPE) for firefighters has traditionally contained flame and heat resistant insulation and a liquid barrier that repel liquids and chemicals. Recently, PPE has been developed that further protects the firefighter from aerosol ingression of soot particulates from smoke, focusing on the head and neck area. These soot and particulate residues generated during structure fires and wildfires can contain toxic organic compounds that are believed to be harmful to the health of the firefighters over time. Over 95% of these burned particulates vary from 2 to 5000 microns in size.

U.S. Pat. No. 11,077,325 to Levit discloses a protective article that is a neck covering, including such things as a cowl, a head covering including such things as hoods, a collar, or a related article that connects protective gear, that is both flame resistant and resistant to the ingression of particles; noting the health threat posed by atomized particles in smoke.

US Pat. Application Publication US 2020/0069980 to Sonntag discloses a firefighter hood protecting the face, neck, and throat areas that provides barrier properties to airborne fine and superfine particulates encountered in fire and other emergencies.

While such prior solutions can mitigate airborne soot and particulates from contacting the head and neck area, challenges remain in preventing potentially toxic soot from contacting the skin of firefighters and other workers on other parts of the body. It is not unusual for a firefighter to wear PPE for multiple times before it is cleaned; however, burn residues or soot can potentially deposit on the PPE during every use. The average size of the ash and other particles found on the surface of PPE may be as small as 1-50 microns.

Current testing of firefighting gear is directed to airborne contaminants. Various air filtration efficiency tests have been used to measure the performance of various fabrics used in gear. The tests, such as ASTM F2299 “Standard Test Method for Determining the Initial Efficiency of Materials Used in Medical Face Masks to Penetration by Particulates Using Latex Spheres” measure the ability of fabrics to prevent passage of aerosol particles at various face velocities (flow rates) and particle sizes.

Additionally, the NFPA 1971 Standard on Protective Ensembles for Structural Fire Fighting and Proximity Fire Fighting—2018 Edition, provides guidance of testing of airborne contaminants. As discussed therein, to test firefighting gear, the gear is donned, and the wearer is exposed for 30 minutes to atomized small particles simulating smoke particles in an aerosol chamber. During the 30 minutes, the wearer performs three stationary exercises as discussed in the NFPA 1971 Standard. After the 30 minute exposure, the gear is removed, and the wearer is evaluated under black light to determine if any particles passed through the gear.

While such airborne protections are important, active firefighters have noticed that their hands, after removing their firefighting gear, are dirty, despite wearing protective thermal gloves. Obviously, the outer surfaces of protective thermal gloves become dirty in use from burn residues or soot. While it is possible these particles might migrate through the seams of the gloves, it is more likely that they enter the interior of the glove via the wrist opening, and the possibility the inside of the protective glove can become contaminated increases with repetitive use. The particles on the inside of the contaminated protective glove are then ground into the skin of the wearer's hands by the additional use of that glove. Additionally, it is not unusual for a firefighter to eat snacks between firefighting activities, therefore eating with dirty hands and fingers can be another pathway for the firefighter to be exposed to potentially toxic particles. By any mechanism, because a firefighter's hands are in constant use, the objectionable particles are constantly being ground into the skin of the wearer's hands.

Therefore, what is needed is a glove assembly and a glove insert that resists the tendency of any soot or residue particles that might migrate into a protective thermal glove from being ground into the skin of the hands of the wearer.

### BRIEF SUMMARY OF THE INVENTION

This invention relates to a glove assembly, comprising:
a) a flame and heat-resistant outer glove, said outer glove having outer glove finger stalls and an outer glove tubular portion forming palm, side, and back-of-hand areas of said outer glove, the outer glove tubular portion ending in an outer glove wrist opening, and
b) a flame and particulate-resistant glove insert, said glove insert having glove insert finger stalls and a glove insert tubular portion forming palm, side, and back-of-hand areas of said glove insert, the glove insert tubular portion ending in a glove insert opening,
wherein the particulate-resistant glove insert is configured to fit over a person's hand and inside the flame and heat-resistant outer glove, the particulate-resistant glove insert being separable from the flame and heat-resistant outer glove, and
wherein the flame and particulate-resistant glove insert comprises a particulate-resistant barrier laminate comprising an exterior layer, a middle layer, and an interior layer, wherein each layer is flame resistant, and
a) the exterior layer comprises a knit fabric having a basis weight of 33.9 to 101.7 grams per square meter (1 to 3 ounces per square yard) and a tightness factor of 0.9 to 1.9;
b) the middle layer comprises flame resistant nonwoven fabric having a basis weight of 5 to 30 grams per square meter (0.15 to 0.88 ounces per square yard), the nonwoven fabric comprising of a plurality of fibers having a diameter of less than 1000 nm, wherein the flame resistant nonwoven fabric has stretch and recovery; and
c) the interior layer comprises a knit fabric having a basis weight of 33.9 to 101.7 grams per square meter (1 to 3 ounces per square yard), and
wherein one surface of the exterior layer is attached to a first surface of the middle layer by adhesive, and one surface of the interior layer is attached to a second surface of the middle layer by adhesive, the adhesive discontinuously present between each of the attached layers, and
wherein the total basis weight of the laminate is 93 to 294 grams per square meter (2.7 to 8.6 ounces per square yard).

This invention also relates to a particulate-resistant glove insert comprising glove insert finger stalls and a glove insert tubular portion forming palm, side, and back-of-hand areas of said glove insert, the glove insert tubular portion ending in a glove insert opening, and
wherein the glove insert finger stalls and glove insert tubular portion comprise a particulate-resistant barrier laminate, said laminate comprising an exterior layer, a middle layer, and an interior layer, wherein each layer is flame resistant, and
a) the exterior layer comprises a knit fabric having a basis weight of 33.9 to 101.7 grams per square meter (1 to 3 ounces per square yard) and a tightness factor of 0.9 to 1.9;
b) the middle layer comprises nonwoven fabric having a basis weight of 5 to 30 grams per square meter (0.15 to 0.88 ounces per square yard), the nonwoven fabric comprising of a plurality of filaments having a diameter of less than 1000 nm, wherein the flame resistant nonwoven fabric has stretch and recovery; and
c) the interior layer comprises a knit fabric having a basis weight of 33.9 to 101.7 grams per square meter (1 to 3 ounces per square yard),
wherein one surface of the exterior layer is adhesively attached to a first surface of the middle layer, and one surface of the interior layer is adhesively attached to a second surface of the middle layer, the adhesive discontinuously present between each of the attached layers, and
wherein the total basis weight of the laminate is 93 to 294 grams per square meter (2.7 to 8.6 ounces per square yard).

This invention further relates to a method of protecting hands of workers from a combination of flame, heat, and particulate hazards, comprising:
i. providing a flame and heat-resistant outer glove, said outer glove having outer glove finger stalls and an outer glove tubular portion forming palm, sides, and back-of-hand areas of said outer glove, the outer glove tubular portion ending in an outer glove wrist opening,
ii) providing a flame and particulate-resistant glove insert, said glove insert having glove insert finger stalls and a glove insert tubular portion forming palm, side, and back-of-hand areas of said glove insert, the glove insert tubular portion ending in a glove insert opening,
   wherein the particulate-resistant glove insert is configured to fit over a person's hand and inside the flame and heat-resistant outer glove, the particulate-resistant glove insert being separable from the flame and heat-resistant outer glove, and
iii) forming a glove assembly by inserting the flame and particulate-resistant glove insert into the outer glove wrist opening of the flame and heat-resistant outer glove,
   wherein each one of the glove insert finger stalls is inserted into and is in contact with a corresponding glove finger stall, and
   wherein the glove insert tubular portion is inserted into and is in contact with the glove tubular portion,
   the flame and particulate-resistant glove insert comprising a particulate-resistant barrier laminate comprising an exterior layer, a middle layer, and an interior layer, wherein each layer is flame resistant, and
   a) the exterior layer comprises a knit fabric having a basis weight of 33.9 to 101.7 grams per square meter (1 to 3 ounces per square yard) and a tightness factor of 0.9 to 1.9;
   b) the middle layer comprises flame resistant nonwoven fabric having a basis weight of 5 to 30 grams per square meter (0.15 to 0.88 ounces per square yard), the nonwoven fabric comprising of a plurality of fibers having a diameter of less than 1000 nm, wherein the flame resistant nonwoven fabric has stretch and recovery; and
   c) the interior layer comprises a knit fabric having a basis weight of 33.9 to 101.7 grams per square meter (1 to 3 ounces per square yard),
   wherein one surface of the exterior layer is attached to a first surface of the middle layer by adhesive, and one surface of the interior layer is attached to a second surface of the middle layer by adhesive, and the adhesive discontinuously present between the attached layers, and
   wherein the total basis weight of the laminate is 93 to 294 grams per square meter (2.7 to 8.6 ounces per square yard).

### BRIEF DESCRIPTION OF THE DRAWINGS

FIG. 1 illustrates an embodiment of a glove assembly comprising a flame and heat-resistant outer glove, and a flame and particulate-resistant glove insert.

FIG. 2 illustrates cross sections an embodiment of a glove assembly, including a flame and heat-resistant outer glove containing a multilayer composite comprising an outer protective shell layer, a liquid-barrier layer, and an insulative layer; and a flame and particulate-resistant glove insert comprising a particulate-resistant barrier laminate having an exterior layer, a middle layer, and an interior layer.

### DETAILED DESCRIPTION OF THE INVENTION

### Glove Assembly

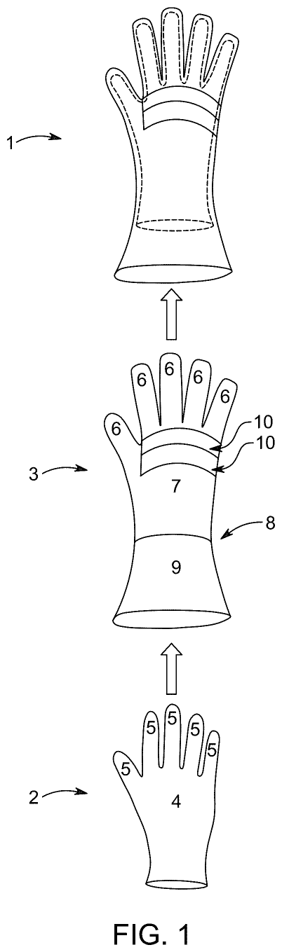

As shown in the embodiment of FIG. 1, the glove assembly 1 comprises a particulate-resistant glove insert 2 and a flame and heat-resistant outer glove 3. As further shown in FIG. 1, the particulate-resistant glove insert 2 is configured to fit over a person's hand and inside the flame and heat-resistant outer glove 3 to form the glove assembly 1, with the particulate-resistant glove insert 2 being separable from the flame and heat-resistant outer glove 3. The particulate-resistant glove insert 2 has a particulate-resistant barrier laminate that prevents particles from migrating through the glove insert by contact pressure, while still allowing moisture vapor to pass. Additionally, the glove insert is thin, lightweight, and separable so that the glove insert can be washed if desired after every use.

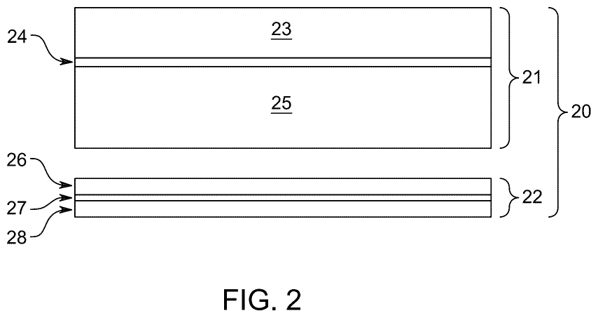

FIG. 2 illustrates idealized but representative cross sections of an embodiment of a glove assembly 20, including cross sections of a flame and heat-resistant outer glove 21 and cross sections of a separable flame and particulate-resistant glove insert 22. These are not drawn to strict scale but are meant to provide some suggestion of the relative proportions of the parts of the assembly. For example, the overall thickness of particulate-resistant glove insert is preferably much less than the overall thickness of the flame and heat-resistant outer glove.

Preferably, the glove assembly meets the dexterity requirements for gloves as outlined in the NFPA 1971 Standard on Protective Ensembles for Structural Fire Fighting and Proximity Fire Fighting—2018 Edition. This standard provides a glove hand function test performed in accordance with ASTM F2010/F2010M, Standard Test Method for Evaluation of Glove Effects on Wearer Hand Dexterity Using a Modified Pegboard Test. In this test, the test subject is timed picking up metal pins and placing them in a horizontal pegboard, first barehanded as a control, and then while wearing gloves. A glove is determined to have adequate dexterity if the test subject can complete the test while wearing gloves within 220 percent of the barehanded control time. For example, if it takes on average 60 seconds to complete the test barehanded, a glove is considered to have adequate dexterity if the same task with gloved hands can be completed with 132 seconds on average. Therefore, the glove assembly preferably has adequate dexterity to meet the requirements of NFPA 1971 (2018 ed) using the ASTM F2010/F2010M test method.

### Flame and Heat-Resistant Outer Glove

Herein, the word “glove” has its usual meaning, of a covering for the hand worn for protection and typically having sections covering each finger, the thumb, as well as the palm, sides, and the back of the hand, and preferably when used in firefighting, at least a portion of wrist. The flame and heat-resistant outer glove preferably meets the design and performance requirements for protective gloves as described in the NFPA 1971 Standard on Protective Ensembles for Structural Fire Fighting and Proximity Fire Fighting—2018 Edition.

As shown in FIG. 1, the flame and heat-resistant outer glove 3 preferably has finger stalls 6 and a tubular portion 7; the tubular portion forms the palm area, the side areas, the back-of-the-hand area, and preferably some portion of the wrist area of the outer glove. For avoidance of doubt, the thumb is considered herein to be a “finger”, and likewise the term “finger stalls” includes finger stalls for all the fingers including the thumb. The sections of glove fully cover each finger as well as the palm area, the side areas, and the back-of-the-hand area of the hand, and at least some portion of the wrist area. In this preferred embodiment, the tubular portion 7 extends past the point 8 signifying the break or bend of the wearer's wrist, additionally fully covering the wrist area and a portion of the arm by extended tubular portion 9, that additionally is flared in this illustration to facilitate donning. The tubular portion 7 further ends in an outer glove wrist opening. This “outer glove wrist opening” as used herein is considered an opening in the flame and heat-resistant outer glove 3 to correspond with the location of the break or bend of the wearer's wrist, or an opening at the end of the extended tubular portion 9. The outer glove wrist opening is sized such that a wearer's hand can enter the outer glove so the outer glove can be worn, and preferably is sized such that a wearer's hand that is further wearing the glove insert described herein can enter the outer glove without undue effort so the outer glove can be worn over the glove insert. The outer glove as shown further comprises protective strips 10 present on the back of the outer glove to provide additional cushioning for the knuckles on the back of the hand of the wearer. These protective strips 10 are typically leather or some other durable material. Additionally, various other strips or layers are possible on the palm side of the outer glove (not shown) that could provide a better gripping surface or other function.

In some embodiments, the flame and heat-resistant outer glove preferably comprises a multilayer composite of an outer protective shell layer, a liquid-barrier layer, and an insulative layer; with the liquid-barrier layer being sandwiched between one surface of the outer protective shell layer and a first surface of the insulative layer. The insulative layer can further comprise a lining fabric on its second surface that forms an inner liner of the flame and heat-resistant outer glove, which is the interior surface of the outer glove and is closest to the wearer's hand. However, other designs are possible as long as they preferably meet the requirements for protective gloves as described in the NFPA 1971 Standard for firefighters. Generally, these gloves are heavy weight, very durable gloves because of their intended use. Further, the individual finger stalls, the palm area, the side areas, the back-of-the-hand area, and any wrist areas of the outer glove can utilize different constructions and material, including fabrics of different types, weights, and coatings. Typically, the material of the individual finger stalls, the palm area, the side areas, the back-of-the-hand area, and any wrist areas has a basis weight of 400 grams/square meter (11.8 ounces/square yard) or higher.

FIG. 2 illustrates a possible cross section of the flame and heat-resistant outer glove 21, preferably containing a multilayer composite comprising an outer protective shell layer 23, a liquid-barrier layer 24, and an insulative layer 25. The protective shell layer 23 forms the outer surface of the outer glove and is therefore the surface that is most exposed to the environment. If the outer glove further comprises protective cushioning strips on the back of the glove, then those protective strips are typically positioned on portions of the outer surface of that protective shell layer 23 on the back-of-the-hand area (and optionally on the side areas) of the outer glove. Likewise, any additional gripping layers on the palm side of the outer glove are typically positioned on portions of the outer surface of the protective shell layer on the palm side of the outer glove. The insulative layer 25 of FIG. 2 is closer to the glove insert and the wearer's hand. If the insulative layer further comprises a lining fabric (not shown), that lining fabric forms the interior surface of the outer glove and is necessarily closer to the glove insert and the wearer's hand. The various layers of the outer glove can be attached together by essentially any method, with stitching being a preferred method.

Therefore, when present, each of the aforementioned preferred layers of the flame and heat-resistant outer glove perform a distinct function. The outer protective shell layer provides flame protection and serves as a primary defense from fire and mechanical challenges for the fire fighter. Adjacent to the outer protective shell layer is the liquid-barrier layer that is preferably moisture vapor permeable. Adjacent to the liquid-barrier layer is the insulative layer. The liquid-barrier layer keeps the insulative layer dry and insulative layer insulates the wearer from heat during firefighting activities.

### Outer Glove Shell Layer

The outer protective shell layer can comprise flame-resistant fabric, leather, or some combination of the two. For example, portions of the back of the hand and the fingers/thumb can have an outer protective shell of flame-resistant fabric, optionally trimmed in leather, while portions of the palm and finger/thumbs can contain some leather for improved gripping.

The flame-resistant fabric of the outer protective shell layer of the flame and heat-resistant outer glove can be a woven or knit fabric and can comprise yarns of fibers that are inherently flame-resistant or have been treated to render them flame-resistant. Exemplary fibers that are inherently flame-resistant include meta-aramid such as Nomex® aramid fibers from DuPont, Wilmington DE. Other fibers in this category include those made from para-aramid, carbon, glass, modacrylic, polyamide-imide, and polybenzazoles such as polyoxazoles and polyimidazoles, along with various aramid and polyazole copolymers. Exemplary inflammable fibers that can be made flame-resistant by treatment or other methods include cellulosic fibers such as cotton, rayon, viscose, and lyocell. Blends of inherently flame-resistant and rendered flame-resistant fibers may also be used. The fibers may be in the form of continuous filament yarns or staple fiber yarns.

As used herein, a polymer or fiber made from a polymer is considered to be fire resistant if the polymer has a limiting oxygen index greater than 21. The fire or flame resistant fiber preferably does not melt, drip, or continue to burn after the heat source is removed. Additionally, as used herein, a fiber or fabric is considered “flame resistant” if a fabric made solely from that fiber has a char length equal to or less than 4 inches (100 mm) and an afterflame equal to or less than 2 seconds per the vertical flame test of ASTM D6413-15.

One popular material for outer glove shell layer is natural leather because of its excellent properties, like its natural protection from flame, good friction grip, and good puncture resistance. However, natural leather gloves can shrink when laundered and firefighters can be reticent to wash their gloves, despite the fact that gloves are known to be much dirtier than other gear worn by fire fighters.

### Outer Glove Liquid-Barrier Layer

The liquid-barrier layer of the flame and heat-resistant outer glove is liquid resistant, but breathable; that is, preferably, the liquid-barrier layer allows water vapor (from evaporating sweat) to pass through the layer, which is an important function when working in a hot environment. In some embodiments, the liquid-barrier layer is a barrier to not only water but also to liquid chemicals and fuels. Typically, the liquid-barrier layer comprises a membrane laminated to a nonwoven or woven fabric. Membrane materials used to laminate to the fabric include such things like polytetrafluoroethylene (PTFE) and polyurethane. Examples of such laminates include Crosstech® PTFE membranes, or materials such as cross-linked polyurethane coated materials, such as available from PIL Membranes Ltd, King's Lynn, England under the tradename Porelle®. An alternative membrane can be a thermoplastic polyurethane (TPU) flame retardant membrane.

### Outer Glove Insulative Layer

The insulative layer of the flame and heat-resistant outer glove reduces the heat flow to the wearer of the glove and can be made from several layers of spunlaced or needlepunched nonwoven material, preferably comprising a fire- or flame-resistant fiber. The insulative layer can further comprise a lining fabric that acts as a facer or facecloth fabric for the insulative layer and forms the innermost layer of the flame and heat-resistant outer glove. Preferably, if present, the lining fabric is a flame-resistant fabric. The insulative layer and optional lining fabric can comprise para-aramid fibers, meta-aramid fibers, polyamide-imide fibers, aramid copolymer fibers, polybenzazole fibers, polybenzimidazole fibers, polyimide fibers, and mixtures thereof. While some preferred materials have been suggested for the insulative layer, it is understood a wide range of materials might be used. Material choices might, for example, include other aramid fibers, polynosic rayon, flame-resistant treated polynosic rayon, viscose rayon, flame-resistant viscose rayon, other cellulosic fibers such as flame-resistant treated cotton or acetate, flame-resistant polyester, polybenzimidazole, polyvinyl alcohol, polytetrafluoroethylene, wool, flame-resistant wool, polyvinyl chloride, polyetheretherketone, polyetherimide, polyethersulfone, polychlal, polymide, polyamide, polyimide-amide, polyolefin, carbon, modacrylic, acrylic, melamine, and glass, and blends made therefrom from any of the materials or fibers mentioned. Additional materials for use as the lining fabric or face cloth include knits, spun-laced and other nonwovens, wovens, stitch-bonded fabrics, and weft-insertion fabrics.

### Flame and Particulate-Resistant Glove Insert

The glove assembly further comprises a flame and particulate-resistant glove insert that is separable from the flame and heat-resistant outer glove and configured to fit over a person's hand and fit inside the flame and heat-resistant outer glove. By separable, it is meant the glove insert can be removed from the glove assembly for washing and reuse without needing to clean the flame and heat-resistant outer glove. The glove insert blocks potentially toxic particulates from migrating from the inside surface of the flame and heat-resistant outer glove and being deposited and ground into the hands of firefighters. Dirty hands may be one of primary sources for firefighter exposure to toxic chemicals.

Herein, “glove insert” is meant to be a covering for the hand typically having individual sections covering each finger, the thumb, as well as the palm, sides, and the back of the hand; including, if desired, at least a portion of the wrist. As shown in FIG. 1, the flame and particulate-resistant glove insert 2 preferably has finger stalls 5 and a tubular portion 4; the tubular portion further forms the palm area, the side areas, the back-of-the-glove area, and at least a portion of the wrist area. Again, for avoidance of doubt, the thumb is considered herein to be a “finger”, and likewise the term “finger stalls” includes finger stalls for all the fingers including the thumb. The sections fully cover each finger as well as the palm area, the side areas, and the-back-of-the-hand of the hand, and preferably at least some portion of the wrist area. The tubular portion 4 further ends in a glove insert opening. This “glove insert opening” as used herein is considered an opening in the glove insert that can generally correspond with the location of the break or bend of the wearer's wrist, or if the tubular portion of the glove insert extends to cover a portion of the arm, an opening at the end of that extension. The glove insert opening is sized such that the wearer's hand can enter the glove insert 2 via the glove insert opening so the glove insert can be worn on the hand. The combination of the wearer's hand covered by the flame and particulate-resistant glove insert 2 can then be inserted into the flame and heat-resistant outer glove 3 such that the outer glove 3 is worn over the glove insert 2 to form the glove assembly 1. In the glove assembly, the flame and particulate-resistant glove insert is sized such that when worn, each of the covered parts of the hand, including the fingers, the palm, and the sides and the back of the hand, fit comfortably inside the flame and heat-resistant outer glove. In some embodiments, the wrist length of the glove insert is less than that of the outer glove, as shown in FIG. 1. In some other embodiments, the wrist length of the glove insert is equal to or longer than the wrist length of outer glove to minimize potential particle migration; with the outer glove wrist length being defined from the break or bend of the wrist to the outer glove opening of the flame and heat-resistant outer glove. In other words, in some embodiments, the wrist length of the glove insert is equal to or longer than any extended tubular portion that may be present on the flame and heat-resistant outer glove. “Wrist length” is considered the length the tubular portion extends up the arm from the break or bend in the wrist, and conceivably can be a negative length if the tubular portion did not extend to the break or bend in the wrist.

The flame and particulate-resistant glove insert is comfortable to wear, i.e. is lightweight and breathable. The design of the glove insert is also compatible with the design of the outer glove, such that the glove insert can be worn inside the flame and heat-resistant outer glove while performing firefighting duties while the glove assembly has adequate dexterity and does not hinder a firefighter from performing critical tasks effectively. While the flame and heat-resistant outer glove is preferably one that meets the design and performance requirements for protective gloves as described in the NFPA 1971 Standard, it is adequate that the flame and particulate-resistant glove insert be made of flame resistant material demonstrating no melt or no drip in flame and having a heat shrinkage of less than 10% after 5 min exposure at 260° C.

In some embodiments, the flame and particulate-resistant glove insert is a fourchette style glove or a gunn style glove, preferably with a wing thumb. A fourchette style glove has a seamless palm area and a seamless back-of-hand area, with gussets bridging the two areas, with the gussets sewn or attached to both areas. There are no seams in any work area. A gunn style glove has a seamless back-of-hand area and side finger seams located closer to the back-of-hand area. Additionally, there is a seam on the palm side at and across the base of the two finger stalls for the second and third fingers, where those finger stalls meet the palm area. This “gunn” seam is located in a natural crease of the hand. In some most preferred embodiments, the flame and particulate-resistant glove insert is a gunn style glove.

### Glove Insert Particulate-Resistant Barrier Laminate

The flame and particulate-resistant glove insert comprises a particulate-resistant barrier laminate. In some embodiments, the laminate of the particulate-resistant glove insert prevents contact migration of particles having a diameter of 1 to 50 microns through the laminate after 100 cycles on a Martindale Machine SDL Atlas M235 using a 140 mm diameter sample under 9 kPa pressure. By “contact migration” it is meant the forcing of particles through the laminate by literal contact of the particles by some object. In use in the glove assembly, such object can be the inside surface of the outer glove, which can press any contaminant particles present in the interior of the outer glove onto the surface of the laminate of the glove insert. The terms “contact migration” and “contact penetration” are used interchangeably herein. In some other embodiments, the laminate of the particulate-resistant glove insert prevents contact migration of particles having a diameter of 1 to 50 microns through the laminate after 500 cycles on a Martindale Machine SDL Atlas M235 using a 140 mm diameter sample under 9 kPa pressure; and in some other embodiments, the laminate of the particulate-resistant glove insert prevents contact migration of particles having a diameter of 1 to 50 microns through the laminate after 1000 cycles on a Martindale Machine SDL Atlas M235 using a 140 mm diameter sample under 9 kPa pressure.

The palm area, the finger stalls, the side areas, the back-of-the-glove area, or the wrist areas of the glove insert can comprise or be made from the particulate-resistant barrier laminate. In some preferred embodiments, all of these areas comprise or are made from the particulate-resistant barrier laminate. In some embodiments the fabric of the glove insert used in the glove insert is solely the particulate-resistant barrier laminate.

The particulate-resistant barrier laminate comprises an exterior layer, a middle layer, and an interior layer; with each of those layers in turn being flame resistant. The exterior layer forms the outer surface of the glove insert, and in use in the glove assembly preferably forms the outer surface of the glove insert and preferably contacts with inner surface of the flame and heat-resistant outer glove; the interior layer preferably forms the inner surface of the glove insert, and in use preferably contacts the firefighter's or wearer's hand. The middle layer is sandwiched between and preferably directly adhered to both the exterior layer and the interior layer. Specifically, in the laminate, one surface of the exterior layer is attached to a first surface of the middle layer by adhesive, and one surface of the interior layer is attached to a second surface of the middle layer by adhesive.

FIG. 2 illustrates a possible cross section of the flame and particulate-resistant glove insert 22 comprising a particulate-resistant barrier laminate having an exterior layer 26, a middle layer 27, and an interior layer 28. For simplicity and clarity, the discontinuous adhesive between the exterior layer 26 and the middle layer 27, and the discontinuous adhesive between the middle layer 27 and the interior layer 28, are not shown. The exterior layer 26 is therefore preferably the surface that is majority contact with the inner surface of the flame and heat-resistant outer glove 21 in the glove assembly; and the interior layer 28 is preferably the inner surface of both the glove assembly and the glove insert, the interior layer 28 preferably being in majority contact with the wearer's hand.

The total basis weight of the laminate of the particulate-resistant barrier laminate of the flame and particulate-resistant glove insert is 93 to 294 grams per square meter (2.7 to 8.6 ounces per square yard). In some embodiments, the total basis weight of the laminate of the particulate-resistant glove insert is 150 to 220 grams per square meter (4.4 to 6.5 ounces per square yard).

The laminate and glove insert preferably have breathability. One indicator of the breathability of a material is its Total Heat Loss (THL). The THL test is a widely used test to evaluate the amount of metabolic heat that can be transferred out of a material via both sweat evaporation from the wear's skin and heat conduction through the material to the outside environment. A high THL measurement indicates a material is more breathable and comfortable. Although at this time there is no requirement for firefighter gloves, the minimum requirement for a protective gear ensemble per the NFPA 1971 standard is it should have a total heat loss (THL) of not less than 205 W/m². In some embodiments, the laminate of the particulate-resistant glove insert and the glove insert have a total heat loss (THL) higher than 500 W/m². In some embodiments, the laminate of the particulate-resistant glove insert and the glove insert have a total heat loss (THL) higher than 580 W/m².

Another indicator of the breathability of a material is its Resistance to Evaporative Transfer (RET). The RET Test simulates the evaporation of sweat from the wear's skin through a material. A smaller the number means less resistance to the evaporation of sweat and a more breathable material. In some embodiments, the laminate of the particulate-resistant glove insert and the glove insert have a resistance to evaporative transfer (RET) that is lower than the 8 kPa·m²/W. In some embodiments, the laminate of the particulate-resistant glove insert and the glove insert have a resistance to evaporative transfer (RET) that is lower than the 6 kPa·m²/W.

### Particulate-Resistant Barrier Laminate Exterior and Interior Layers

The exterior layer and the interior layer function as coverings for the lightweight middle layer of the particulate-resistant barrier laminate and synergistically work with the middle layer in the insert to prevent particle migration through the laminate. The exterior layer serves to block larger particles, while not suffocating or compromising the middle layer from blocking smaller particles. The interior layer prevents the middle layer from being abraded by the features of the fingers/thumb, the palm, and back of the hand, which could compromise the function of the lightweight middle layer.

Both the exterior layer and the interior layer comprise a knit fabric. The knit fabric of the exterior layer has a tightness factor of 0.9 to 1.9. In some embodiments, the tightness factor is greater than 1.1, and in some embodiments, the tightness factor is less than 1.8. In some embodiments, the tightness factor of the exterior layer can be 1.1 to 1.8; or 1.4 to 1.7. The exterior layer serves to block larger particles, which is not a requirement of the interior layer; however, in some embodiments, the knit fabric of the interior layer can also have a tightness factor of 0.9 to 1.9; and in some embodiments, the tightness factor of the interior layer can be greater than 1.1. In some embodiments, the tightness factor of the interior layer can be less than 1.8, or the tightness factor can be 1.1 to 1.8; or 1.4 to 1.7.

The tightness factor of a knit fabric is defined as the ratio of the fabric area covered by the yarn to the total fabric area. It is regarded as a measure of the looseness or tightness of the structure. (Tightness factor of knits is discussed in Eltahan et al., “Determination of Loop Length, Tightness Factor, and Porosity of Single Jersey Knitted Fabric”, Alexandria Engineering Journal (2016) 55, pp. 851-856.) For the purposes herein, the tightness factor can be determined in the following manner using the following equations:

$$Tightness Factor = \frac{\sqrt{tex}}{l}$$

wherein tex is the yarn count (linear density) in tex and (l) is the loop length in millimeters. The loop length (l) is the length of yarn in a single knit loop in a knitted fabric, which is calculated as follows:

$$loop length ( l ) = 0.8 A + 2.58 B + 4.26 d$$

where d=yarn diameter in mm, A=1/(wales per mm), and B=1/(courses per mm). The yarn diameter d can be visually measured by a calibrated micrometer, or can be calculated from the yarn count by using the following equation:

$$yarn diameter = 20 {( yarn count / yarn linear density / 314159 )}^{1 / 2}$$

wherein the yarn diameter d has the units of millimeters (mm), the yarn count has the units of tex, and the yarn linear density has the units of g/cm³.

Both the exterior layer and the interior layer comprise a knit fabric having a basis weight of 33.9 to 101.7 grams per square meter (1 to 3 ounces per square yard). In some embodiments, the knit fabric of the exterior layer or the interior layer of the particulate-resistant glove insert has a basis weight of 50 to 80 grams per square meter (1.5 to 2.4 ounces per square yard). In some other embodiments, the knit fabric of both the exterior layer and the interior layer of the particulate-resistant glove insert has a basis weight of 50 to 80 grams per square meter (1.5 to 2.4 ounces per square yard).

In some embodiments, the knit fabric of the exterior layer or the interior layer of the particulate-resistant glove insert comprises yarn having a linear density of 80 to 250 denier; and in some embodiments the knit fabric of either layer comprises yarn having a linear density of 100 to 200 denier. Preferably, both the exterior layer and the interior layer of the particulate-resistant glove insert comprise yarns having a linear density of 80 to 250 denier. In some embodiments, both the exterior and the interior layer comprise yarn having a linear density of 100 to 200 denier.

The two knit fabrics can be the same or different. For example, the knit construction, basis weight, yarn density, and/or tightness factor of the exterior layer can be different from that of the interior layer, within the boundaries described herein.

To assist in making the particulate-resistant barrier laminate and the particulate-resistant glove insert flame resistant, the knit fabric of the exterior layer or the interior layer of the barrier laminate and glove insert can comprise yarns containing fire resistant fibers. Such fibers can include meta-aramid fibers, para-aramid fibers, polyamide-imide fibers, aramid copolymer fibers, polybenzazole fibers, polybenzimidazole fibers, polyimide fibers, and mixtures thereof. Other fire resistant fibers that might be used include flame-resistant(FR) rayons, such as FR polynosic rayon and FR viscose rayon, FR cellulosics such as FR cotton or FR acetate, cotton, or wool, including FR wool. Some preferred fire resistant fibers are aramid fiber, preferably meta-aramid fibers, in particular poly(metaphenylene isophthalamide) fibers; and FR rayon fibers, and blends of those fibers. Preferably, the fibers having a limiting oxygen index (LOI) of at least 21, preferably at least 26 or higher.

### Particulate-Resistant Barrier Laminate Middle Layer

The middle layer comprises flame resistant nonwoven fabric having a basis weight of 5 to 30 grams per square meter (0.15 to 0.88 ounces per square yard); the nonwoven fabric further comprises of a plurality of fibers having a diameter of less than 1000 nm and the nonwoven fabric has stretch and recovery. In some preferred embodiments, the flame resistant nonwoven fabric having stretch and recovery of the middle layer has a first direction, such as the machine direction, and a second direction that is perpendicular to the first direction, such as the cross direction, and the plurality of fibers is substantially oriented parallel with either the first direction or the second direction. This gives the flame resistant nonwoven fabric stretch and recovery in the perpendicular second direction or first direction, respectively. Preferably the first direction is the machine direction, giving the flame resistant nonwoven fabric stretch and recovery in the second direction, which is the cross direction. As is well known in the art, the machine direction is understood to be the direction of manufacture of the nonwoven fabric, while the cross direction is perpendicular to the direction of manufacture of the nonwoven fabric.

If the flame resistant nonwoven fabric having stretch and recovery of the middle layer has a plurality of fibers substantially oriented parallel with either the machine direction or the cross direction, it is preferred that the flame resistant nonwoven fabric be incorporated in the glove insert in a manner that these substantially oriented parallel fibers are oriented parallel to the parallel array of finger stalls of the glove. This allows both the tubular portion of the glove insert and the finger stalls to expand cylindrically as the glove insert is being donned and allows some stretch and recovery of the glove insert while being worn and used.

The fibers in the nonwoven fabric of the middle layer have an average diameter of less than 1000 nm, which can be measured by scanning electronic microscope; these are commonly called nanofibers. Processes for making nonwoven sheets comprising nanofibers include electroblowing processes such as disclosed in representative publications PCT Pub. No. WO2003/080905; U.S. Pat. No. 4,172,706; and U.S. Pat. Appl. Pub. 2005/0067732; although any method that creates a suitable nonwoven sheet comprising nanofibers having stretch and recovery could be used, within the boundaries described herein. The electroblowing method comprises feeding a solution of a polymer in a solvent from a mixing chamber through a spinning beam, to a spinning nozzle to which a high voltage is applied, while compressed gas is directed toward the polymer solution in a blowing gas stream as it exits the nozzle. Nanofibers are formed and collected as a web on a grounded collector under vacuum. The collected nanofibers are advantageously bonded together in the nonwoven, forming the useful middle layer described herein. The bonding may be accomplished by known methods, including but not limited to thermal calendering between heated smooth or embossed nip rolls, ultrasonic bonding, and through gas bonding. Bonding increases the strength and the compression resistance of the nonwoven sheet of nanofibers so that it may withstand the forces associated with being handled. It can also adjust the physical properties of the nonwoven sheet such as thickness, density, and the size and shape of the pores. For instance, thermal calendering can be used to reduce the thickness and increase the density and solidity of the sheet and reduce the size of the pores. Thermal calendering can also decrease the flow rate through the medium at a given applied differential pressure.

In some preferred embodiments, the nonwoven sheet comprising nanofibers is a calendered sheet that was bonded between heated smooth nip rolls to the degree necessary to provide the desired thickness, air permeability, and mean flow pore size. The porosity of the nonwoven sheet comprising nanofibers is at least 60%, preferably 75% to 95%. In some most preferred embodiments, the flame resistant nonwoven fabric has porosity of 85-95% and a mean pore size of less than 0.9 microns. A small pore size is good for blocking particles while high porosity means comfort and breathability. The flame resistant nonwoven fabric as described herein provides these two seemly-conflicted performance requirements.

The fire resistant fibers of the middle layer are preferably nanofibers is made from a synthetic polymer having a limiting oxygen index (LOI) of at least 21, preferably at least 26 or higher. The fire resistant nanofibers can comprise a single polymer or a mixture of polymers, or if desired, the nonwoven sheet can comprise two or more different types of polymer nanofibers. Useful polymers for making the nanofibers include such things as polyimide (including fully aromatic polyimide), aromatic polyamide, polyareneazole, melamine, polyacrylonitrile, oxidized polyacrylonitrile, polyethersulphone, polysulphone, polyvinylidene-fluoride and mixtures thereof. In some embodiments, synthetic polymers containing polyimide, meta-aramid, para-aramid, polybenzazole, and polybenzimidazole repeat units are preferred. In some preferred embodiments, the fibers of the flame resistant nonwoven fabric of the middle layer of the particulate-resistant glove insert comprise aromatic polyimide.

### Particulate-Resistant Barrier Laminate Adhesive

In the laminate of the particulate-resistant barrier laminate of the particulate-resistant glove insert, both the exterior layer and interior layers are attached to opposing surfaces of the middle layer by an adhesive. The adhesive is discontinuously present between both the exterior layer and the middle layer, and the interior layer and the middle layer. That is, the adhesive does not continuously cover either surface of the middle layer or either the exterior or interior layer, nor does the adhesive form a continuous layer between any of those layers. The lack of a continuous adhesive layer allows the laminate to “breathe”, allowing moisture vapor to move through the laminate between the adhesive tie points. The adhesive can be applied discontinuously to one or both of the middle layer or the exterior/interior layer, preferably in a regular pattern using a suitable technique such as direct gravure printing that provides individual domains of adhesive on the surface of a layer that are separated by regular areas of the surface without adhesive. These domains create tie or bond points between the layers. The discontinuous adhesive may be applied in any desired pattern, e.g., lines, dots, polygons, or other shapes. Some suitable methods for applying an adhesive in a discontinuous pattern and attaching sheet materials are described, for example, in U.S. Pat. Nos. 5,874,140; 5,531,419; 7,55,377; and U.S. Pat. Pub. US20050130521A1, all to Wyner, et al.

In some embodiments, the weight of the adhesive attaching the first surface of the middle layer to the surface of the exterior layer, or the weight of adhesive attaching the second surface of the middle layer to the surface of the interior layer, is 10-30 g/m². In some embodiments, the weight of the adhesive attaching the first surface of the middle layer to the surface of the exterior layer and the weight of adhesive attaching the second surface of the middle layer to the surface of the interior layer are both each 10-30 g/m². The amount of adhesive applied between the said layers can be the same or different.

Preferably, the first surface of the middle layer is attached to the surface of the exterior layer, and/or the second surface of the middle layer is attached to the surface of the interior layer, using adhesive dots applied between the layers.

In some embodiments, the adhesive covers 40 to 60 percent of each of the first and/or second surface(s) of the middle layer. In some embodiments, the adhesive covers 45 to 55 percent of each of the first and/or second surface(s) of the middle layer.

### Method of Protecting Hands

This invention further relates to a method of protecting hands of workers from a combination of flame, heat, and particulate hazards, comprising:
i. providing a flame and heat-resistant outer glove, said outer glove having outer glove finger stalls and an outer glove tubular portion forming palm, sides, and back-of-hand areas of said outer glove, the outer glove tubular portion ending in an outer glove wrist opening,
ii) providing a flame and particulate-resistant glove insert, said glove insert having glove insert finger stalls and a glove insert tubular portion forming palm, side, and back-of-hand areas of said glove insert, the glove insert tubular portion ending in a glove insert opening,
   wherein the particulate-resistant glove insert is configured to fit over a person's hand and inside the flame and heat-resistant outer glove, the particulate-resistant glove insert being separable from the flame and heat-resistant outer glove, and
iii) forming a glove assembly by inserting the flame and particulate-resistant glove insert into the outer glove wrist opening of the flame and heat-resistant outer glove,
   wherein each one of the glove insert finger stalls is inserted into and is in contact with a corresponding outer glove finger stall, and
   wherein the glove insert tubular portion is inserted into and is in contact with the outer glove tubular portion;
the flame and particulate-resistant glove insert comprising a particulate-resistant barrier laminate comprising an exterior layer, a middle layer, and an interior layer,
   wherein each layer is flame resistant, and
      a) the exterior layer comprises a knit fabric having a basis weight of 33.9 to 101.7 grams per square meter (1 to 3 ounces per square yard) and a tightness factor of 0.9 to 1.9;
      b) the middle layer comprises flame resistant nonwoven fabric having a basis weight of 5 to 30 grams per square meter (0.15 to 0.88 ounces per square yard), the nonwoven fabric comprising of a plurality of fibers having a diameter of less than 1000 nm, wherein the flame resistant nonwoven fabric has stretch and recovery; and
      c) the interior layer comprises a knit fabric having a basis weight of 33.9 to 101.7 grams per square meter (1 to 3 ounces per square yard),
   wherein one surface of the exterior layer is attached to a first surface of the middle layer by adhesive, and one surface of the interior layer is attached to a second surface of the middle layer by adhesive, wherein the adhesive is discontinuously present between the attached layers, and
   wherein the total basis weight of the laminate is 93 to 294 grams per square meter (2.7 to 8.6 ounces per square yard).

One method of iii) forming the glove assembly is for a worker to first don a flame and particulate-resistant glove insert by inserting his or her hand into a glove insert via the glove insert opening, extending the fingers of each hand into the glove insert finger stalls to encompass the fingers while covering the palm, sides, and back-of-the-hand areas of the hand by the glove insert tubular portion. The worker can then don the flame and heat-resistant outer glove by inserting the glove insert covered hand into the outer glove via the outer glove wrist opening, extending the finger-encompassing glove insert finger stalls into the outer glove finger stalls while covering the palm, sides, and back-of-the-hand areas of the glove insert tubular portion with the outer glove tubular portion. While this can be a convenient method of forming the glove assembly, other methods are possible, such as placing the flame and particulate-resistant glove insert inside the flame and heat-resistant outer glove to form the glove assembly, and then donning that glove assembly.

In some embodiments, the flame and heat-resistant outer glove comprises a multilayer composite of an outer protective shell layer, a liquid-barrier layer, and an insulative layer; with the liquid-barrier layer being sandwiched between one surface of the outer protective shell layer and a first surface of the insulative layer. In some embodiments, the flame and particulate-resistant glove insert has a fourchette style or a gunn style.

For avoidance of doubt, of the properties, features, materials, characteristics, and elements of the glove assembly, the flame and heat-resistant outer glove, and the flame and particulate-resistant glove insert previously discussed herein further apply to this method of protecting the hands of workers, including firefighters.

After the glove assembly has been used, if desired, the glove insert can be removed from the outer glove, washed to remove any particulate matter present, and then reused in the glove assembly.

### Test Methods

Vertical Flame Test. Vertical flame performance was measured using ASTM D6413-15.

Basis Weight. The basis weight of the laminate and individual layers was determined according to ASTM D3776/D3776M-20

Porosity. Porosity was calculated by dividing the basis weight of the sample in g/m² by the polymer density in g/cm³ and by the sample thickness in micrometers and multiplying by 100 and subsequently subtracting from 100%, i.e., percent porosity=100−[basis weight/(density×thickness)]×100.

Mean Flow Pore. The mean flow pore (pore size) is the pore diameter at a pressure drop at which the flow through a wetted medium is 50% of the flow through the dry medium was measured according to ASTM F316-19.

Resistance to Evaporative Transfer (RET). The resistance to evaporative transfer was measured according to ASTM F1868-23 Procedure Part B.

Total Heat Loss (THL). The total heat lost (THL) was measured according to ASTM F1868-23 Part C.

Thickness. The thickness of the laminate and individual layers was determined according to ASTM D1777-19.

Limiting Oxygen Index. The limiting oxygen index was measured in accordance with ASTM D2863-23.

Heat Shrinkage. Heat shrinkage of fabrics and articles is determined according to ASTM F2819-21.

### EXAMPLES

### Comparison Example

A 153 g/m² single layer interlock knit fabric was knitted from a 22.2 tex (200 denier) yarn having a 0.14 mm diameter made from a staple fiber blend of 34 weight percent meta-aramid (poly metaphenylene isophthalamide) staple fibers, 33 weight percent modacrylic staple fibers and 33 weight percent FR rayon staple fibers. The knit fabric had a tightness factor of 1.62.

The ability of the knit to resist contact penetration of particles was tested using an SDL Atlas Martindale M235 Abrasion and Pilling Tester having a 120 mm abrading table and a 29 mm abrader. A 140 mm diameter circular sample of the knit was cut and secured on the abrading table. The 29 mm abrader was then covered with CrossTech® black membrane (Available from W. L. Gore). This membrane was chosen because it is impermeable to particles having a particle size larger than 1 micron.

0.1 grams of Glow-In-The-Dark blue pigment made by Art'N Glow was then dispersed as evenly as possible on the top surface of the knit sample. This pigment is designed with phosphorescent crystal and has a maximum particle size of 30 to 50 microns. The Martindale test was then run with the abrader set for 9 kPa pressure on the sample. After 50 cycles, the bottom surface of the knit and the abrading table were visually inspected under black light, and both showed pigment particles had passed through the knit.

### Example 1

The Comparison Example was repeated, however the fabric used was a particulate-resistant barrier laminate that was a 3-layer fabric laminate.

In the particulate-resistant barrier laminate, the exterior or top layer was a 60 g/m² single layer jersey knit fabric knitted from a 22.2 tex (200 denier) yarn having a 0.14 mm diameter made from a staple fiber blend of 50 weight percent meta-aramid (poly metaphenylene isophthalamide) staple fibers and 50 weight percent FR rayon staple fibers. The knit fabric had a tightness factor of 1.68. The middle layer of the laminate was a 24 g/m² polyimide submicron nonwoven fabric having an average pore size less than 1 micron. The interior or bottom layer of the laminate was a 70 g/m² single layer jersey knit fabric knitted from a 11.3 tex (100 denier) yarn made from 100 weight percent meta-aramid (poly metaphenylene isophthalamide) staple fiber. The knit fabric had a tightness factor of 1.22. The exterior (top) and Interior (bottom) layers were each attached to the middle layer by a plurality of dot-like areas of a FR polyurethane adhesive that covered about 50% of each surface of the middle layer in a consistent and repeated manner. The total assembled laminate had a basis weight of 190 g/m².

A sample of the particulate-resistant barrier laminate was conditioned at 70° F. at 65% relative humidity for more than 24 hrs. Five specimens in warp and fill direction were cut in 3″×12″ in size and tested for flame and heat resistant characteristics in accordance with ASTM D6413 and averaged. During the 12 second flame exposure, no melting or dripping was observed. After flame was removed, the average afterflame for lengthwise and widthwise specimens was 0.36 and 0.37 seconds, respectively. The average char length was 8 mm and 7 mm, respectively.

A sample of barrier laminate was conditioned at 70° F. at 65% relative humidity for more than 24 hrs and then placed on a sweating hot plate made by Thermetrics in accordance with ASTM F1868. The inner layer of the sample was placed against to the sweating hot plate, simulating the inner layer sitting next to sweaty human skin. The Part B of the standard test method was used to measure the evaporative resistance (RET) of the sample, while the Part C was applied to determine the metabolic heat resistance (THL). The RET and THL was determined to be 5.9 kPa·m²/W and 609 W/m², respectively.

### Particle Testing

The ability of the laminate to resist contact penetration of particles was tested as in the Comparison Example; that is, using an SDL Atlas Martindale M235 Abrasion and Pilling Tester having a 120 mm abrading table and a 29 mm abrader with a 140 mm diameter circular sample of the knit was cut and secured on the abrading table.

As before, pigment was dispersed on the exterior or top layer of the sample of laminate and the Martindale test was run as in the Comparison Example, however in this instance, the test was stopped after 100 cycles and the sample and abrading table was visually inspected under black light for pigment particles. No pigment was seen on the interior or bottom surface of the sample or the abrading table. The testing was continued for an additional 400 cycles for a total of 500 cycles, and the sample and abrading table were again visually inspected under black light for pigment particles, and no pigment was seen on either the bottom surface of the sample or the abrading table. The testing was continued for another 500 cycles, for a total of 1000 cycles; and again no pigment was seen by visual inspection under black light on either the bottom surface of the sample or the abrading table.

Three additional samples of the identical particulate-resistant barrier laminate were tested for 1000 cycles. After the testing, no pigment was seen by visual inspection under black light on either the interior or bottom surface of any of the samples or their associated abrading table.

### Example 2

After the testing was completed in Example 1, each of the four samples of particulate-resistant barrier laminate were washed and dried in accordance with AATCC 135 Home Laundry standard using 1(A) and (Ai) Normal, respectively. By visual inspection under the black light, none of the four washed and dried samples showed any pigment particles on either the top or bottom of the samples. The four samples were then again Martindale tested as in Example 1, again using 0.1 grams of the pigment on the top surface of each sample. After 1000 cycles, no pigment was seen by visual inspection under black light on either the bottom surface of any of the samples or their associated abrading table.

This example illustrates that any small particles ground into the particulate-resistant barrier laminate were removed by the one-time home laundering; and the particulate-resistant barrier laminate retains its barrier performance after such laundering.

### Example 3

Flame and particulate-resistant glove inserts are made by cutting the laminate of Example 1 into two difference styles of glove patterns and sewing the patterns together to make the glove inserts.

The first glove insert style involves a fourchette pattern with wing thumb. The style has a seamless palm and a seamless back, along with three diamond shaped finger sidewalls located in between the fingers. The finger sidewalls are designed to provide finger stalls with depth for better fit. Each side of each finger is surrounded by two seams with one additional seam on the top of each finger. An elastic band is sewn into the glove insert between the palm and the glove insert opening such that when the glove insert is worn, the tubular portion of the glove insert at the elastic band grips the wrist to help close the opening and minimize entry of particulates during use.

The second glove insert is a gunn style with wing thumb. The style has a seamless back and a horizontal seam in the upper palm area directly below the center two fingers. This style is preferred for heavy duty gloves because the gunn seam below the fingers is located in a natural crease for the hand between the fingers and the palm and therefore is not a source of additional discomfort. Each side of all fingers is surrounded by one seam including the tip of the finger. Again, an elastic band is sewn into the glove insert between the palm and the glove insert opening such that when the glove insert is worn, the tubular portion of the glove insert at the elastic band grips the wrist to help close the opening and minimize entry of particulates during use.

### Example 4

A glove assembly is made by inserting a flame and particulate-resistant glove insert as made in Example 3 and comprising a particulate-resistant barrier laminate as made in Example 1, into a flame and heat-resistant outer glove. The flame and heat-resistant outer glove has an outer shell layer of a heat-resistant and water-repellent soft goatskin split leather, a liquid-barrier layer of a woven aramid faced expanded PTFE membrane, and an insulative layer of an aramid-wool fiber blend felt.

To form the assembly, the flame and particulate-resistant glove insert is first donned by a wearer, to cover the hand of the wearer; followed by donning the flame and heat-resistant outer glove over the glove insert. The dexterity of the glove assembly is tested to according to NFPA 1971-2018 and meets the standard.

The glove assembly is used by a firefighter in a fire fighting situation, and afterwards the glove assembly is examined. Black soot and particles are noted on the outer surface of the glove assembly, specifically on the outer surface of the flame and heat-resistant outer glove. The outer glove is then removed from the glove assembly and some black soot and particles are noted on some portions on the interior surface of the outer glove and also on the outer surface of the glove insert. The glove insert is then removed, and no black soot or particles are noted on the hand of the firefighter.

The glove insert is then washed. The glove assembly is reassembled, this time using the previously used and soiled flame and heat-resistant outer glove. Again, the glove assembly is used by a firefighter in a fire fighting situation, and afterwards the glove assembly is examined. Black soot and particles are again noted on the outer surface of the glove assembly, specifically on the outer surface of the flame and heat-resistant outer glove. The outer glove is then removed from the glove assembly and some black soot and particles are again noted on some portions on the interior surface of the outer glove and also on the outer surface of the glove insert. The glove insert is then removed, and no black soot or particles are noted on the hand of the firefighter.

1. A glove assembly, comprising:
a) a flame and heat-resistant outer glove, said outer glove having outer glove finger stalls and an outer glove tubular portion forming palm, side, and back-of-hand areas of said outer glove, the outer glove tubular portion ending in an outer glove wrist opening, and
b) a flame and particulate-resistant glove insert, said glove insert having glove insert finger stalls and a glove insert tubular portion forming palm, side, and back-of-hand areas of said glove insert, the glove insert tubular portion ending in a glove insert opening, wherein the particulate-resistant glove insert is configured to fit over
a person's hand and inside the flame and heat-resistant outer glove, the particulate-resistant glove insert being separable from the flame and heat-resistant outer glove, and
wherein the flame and particulate-resistant glove insert comprises a particulate-resistant barrier laminate comprising an exterior layer, a middle layer, and an interior layer,
wherein each layer is flame resistant, and
a) the exterior layer comprises a knit fabric having a basis weight of 33.9 to 101.7 grams per square meter (1 to 3 ounces per square yard) and a tightness factor of 0.9 to 1.9;
b) the middle layer comprises flame resistant nonwoven fabric having a basis weight of 5 to 30 grams per square meter (0.15 to 0.88 ounces per square yard), the nonwoven fabric comprising of a plurality of fibers having a diameter of less than 1000 nm, wherein the flame resistant nonwoven fabric has stretch and recovery; and
c) the interior layer comprises a knit fabric having a basis weight of 33.9 to 101.7 grams per square meter (1 to 3 ounces per square yard), and
wherein one surface of the exterior layer is attached to a first surface of the middle layer by adhesive, and one surface of the interior layer is attached to a second surface of the middle layer by adhesive, the adhesive discontinuously present between each of the attached layers, and
wherein the total basis weight of the laminate is 93 to 294 grams per square meter (2.7 to 8.6 ounces per square yard).

2. The glove assembly of claim 1, wherein the laminate of the particulate-resistant glove insert prevents contact migration of particles having a diameter of 1 to 50 microns through the laminate after 100 cycles on a Martindale Machine SDL Atlas M235 using a 140 mm diameter sample under 9 kPa pressure.

3. The glove assembly of claim 1, wherein the total basis weight of the laminate of the particulate-resistant glove insert is 150 to 220 grams per square meter (4.4 to 6.5 ounces per square yard).

4. The glove assembly of claim 1, wherein the knit fabric of the exterior layer or the interior layer of the particulate-resistant glove insert has a basis weight of 50 to 80 grams per square meter (1.5 to 2.4 ounces per square yard)

5. The glove assembly of claim 1, wherein the flame resistant nonwoven fabric of the middle layer of the particulate-resistant glove insert has a first direction and a second direction perpendicular to said first direction, and the plurality of fibers is substantially oriented parallel with the first direction, wherein the flame resistant nonwoven fabric has stretch and recovery in the second direction.

6. The glove assembly of claim 1, wherein the fibers of the flame resistant nonwoven fabric of the middle layer of the particulate-resistant glove insert comprise aromatic polyimide.

7. The glove assembly of claim 1, wherein the flame resistant nonwoven fabric has porosity of 85-95% and a mean pore size of less than 0.9 microns.

8. The glove assembly of claim 1, wherein the weight of adhesive attaching the first surface of the middle layer to the surface of the exterior layer or the weight of adhesive attaching the second surface of the middle layer to the surface of the interior layer is 10-30 g/m².

9. The glove assembly of claim 1, wherein the laminate of the particulate-resistant glove insert has a total heat loss (THL) higher than 500 W/m².

10. The glove assembly of claim 1, wherein the laminate of the particulate-resistant glove insert has a resistance to evaporative transfer (RET) that is lower than the 8 kPa·m²/W.

11. The glove assembly of claim 1, wherein the glove insert has a fourchette style or a gunn style.

12. A particulate-resistant glove insert comprising glove insert finger stalls and a glove insert tubular portion forming palm, side, and back-of-hand areas of said glove insert, the glove insert tubular portion ending in a glove insert opening, and
wherein the glove insert finger stalls and glove insert tubular portion comprise a particulate-resistant barrier laminate, said laminate comprising an exterior layer, a middle layer, and an interior layer, wherein each layer is flame resistant, and
a) the exterior layer comprises a knit fabric having a basis weight of 33.9 to 101.7 grams per square meter (1 to 3 ounces per square yard) and a tightness factor of 0.9 to 1.9;
b) the middle layer comprises nonwoven fabric having a basis weight of 5 to 30 grams per square meter (0.15 to 0.88 ounces per square yard), the nonwoven fabric comprising of a plurality of filaments having a diameter of less than 1000 nm, wherein the flame resistant nonwoven fabric has stretch and recovery; and
c) the interior layer comprises a knit fabric having a basis weight of 33.9 to 101.7 grams per square meter (1 to 3 ounces per square yard),
wherein one surface of the exterior layer is adhesively attached to a first surface of the middle layer, and one surface of the interior layer is adhesively attached to a second surface of the middle layer, the adhesive discontinuously present between each of the attached layers, and
wherein the total basis weight of the laminate is 93 to 294 grams per square meter (2.7 to 8.6 ounces per square yard).

13. The particulate-resistant glove insert of claim 12, wherein the laminate of the particulate-resistant glove insert prevents contact migration of particles having a diameter of 1 to 50 microns through the laminate after 100 cycles on a Martindale Machine SDL Atlas M235 using a 140 mm diameter sample under 9 kPa pressure.

14. The particulate-resistant glove insert of claim 12, wherein the total basis weight of the laminate of the particulate-resistant glove insert is 150 to 220 grams per square meter (4.4 to 6.5 ounces per square yard).

15. The particulate-resistant glove insert of claim 12, wherein the knit fabric of the exterior layer or the interior layer of the particulate-resistant glove insert has a basis weight of 50 to 80 grams per square meter (1.5 to 2.4 ounces per square yard)

16. The particulate-resistant glove insert of claim 12, wherein the flame resistant nonwoven fabric of the middle layer of the particulate-resistant glove insert has a has a first direction and a second direction perpendicular to said first direction, and the plurality of fibers is substantially oriented parallel with the first direction, wherein the flame resistant nonwoven fabric has stretch and recovery in the second direction.

17. The particulate-resistant glove insert of claim 12, wherein the fibers of the flame resistant nonwoven fabric of the middle layer of the particulate-resistant glove insert comprise aromatic polyimide.

18. The particulate-resistant glove insert of claim 12, wherein the flame resistant nonwoven fabric has porosity of 85-95% and a mean pore size of less than 0.9 microns.

19. The particulate-resistant glove insert of claim 12, wherein the weight of adhesive attaching the first surface of the middle layer to the surface of the exterior layer or the weight of adhesive attaching the second surface of the middle layer to the surface of the interior layer is 10-30 g/m².

20. The particulate-resistant glove insert of claim 12, wherein the laminate of the particulate-resistant glove insert has a total heat loss (THL) higher than 500 W/m².

21. The particulate-resistant glove insert of claim 12, wherein the laminate of the particulate-resistant glove insert has a resistance to evaporative transfer (RET) that is lower than the 8 kPa·m²/W.

22. The particulate-resistant glove insert of claim 12, wherein said glove insert has a fourchette style or a gunn style.

23. A method of protecting hands of workers from a combination of flame, heat, and particulate hazards, comprising:
i) providing a flame and heat-resistant outer glove, said outer glove having outer glove finger stalls and an outer glove tubular portion forming palm, sides, and back-of-hand areas of said outer glove, the outer glove tubular portion ending in an outer glove wrist opening, and
ii) providing a flame and particulate-resistant glove insert, said glove insert having glove insert finger stalls and a glove insert tubular portion forming palm, side, and back-of-hand areas of said glove insert, the glove insert tubular portion ending in a glove insert opening,
wherein the particulate-resistant glove insert is configured to fit over a person's hand and inside the flame and heat-resistant outer glove, the particulate-resistant glove insert being separable from the flame and heat-resistant outer glove, and
iii) forming a glove assembly by inserting the flame and particulate-resistant glove insert into the outer glove wrist opening of the flame and heat-resistant outer glove,
wherein each one of the glove insert finger stalls is inserted into and is in contact with a corresponding outer glove finger stall, and
wherein the glove insert tubular portion is inserted into and is in contact with the outer glove tubular portion,
the flame and particulate-resistant glove insert comprising a particulate-resistant barrier laminate comprising an exterior layer, a middle layer, and an interior layer,
wherein each layer is flame resistant, and
a) the exterior layer comprises a knit fabric having a basis weight of 33.9 to 101.7 grams per square meter (1 to 3 ounces per square yard) and a tightness factor of 0.9 to 1.9;
b) the middle layer comprises flame resistant nonwoven fabric having a basis weight of 5 to 30 grams per square meter (0.15 to 0.88 ounces per square yard), the nonwoven fabric comprising of a plurality of fibers having a diameter of less than 1000 nm, wherein the flame resistant nonwoven fabric has stretch and recovery; and
c) the interior layer comprises a knit fabric having a basis weight of 33.9 to 101.7 grams per square meter (1 to 3 ounces per square yard),
wherein one surface of the exterior layer is attached to a first surface of the middle layer by adhesive, and one surface of the interior layer is attached to a second surface of the middle layer by adhesive, wherein the adhesive is discontinuously present between the attached layers, and
wherein the total basis weight of the laminate is 93 to 294 grams per square meter (2.7 to 8.6 ounces per square yard).

24. A method of claim 23, wherein the flame and heat-resistant outer glove comprises a multilayer composite of an outer protective shell layer, a liquid-barrier layer, and an insulative layer; with the liquid-barrier layer being sandwiched between one surface of the outer protective shell layer and a first surface of the insulative layer.

25. The method of claim 23, wherein said glove insert has a fourchette style or a gunn style.
